(19) United States
(12) Patent Application Publication
(10) Pub. No.: US 2026/0361235 A1
(43) Pub. Date: Nov. 12, 2026

(54) ELECTRIC POWER CONVERSION DEVICE AND FLYING OBJECT

(71) Applicants: Mitsubishi Electric Corporation, Tokyo (JP); OSAKA SANGYO UNIVERSITY, Osaka (JP)

(72) Inventors: Kenji FUJIWARA, Tokyo (JP); Akihiko IWATA, Osaka (JP)

(73) Assignees: Mitsubishi Electric Corporation, Tokyo (JP); OSAKA SANGYO UNIVERSITY, Osaka (JP)

(21) Appl. No.: 19/129,030

(22) PCT Filed: Nov. 17, 2022
(86) PCT No.: PCT/JP2022/042672

§ 371 Date: May 12, 2025

(51) Int. Cl. H02M 7/49; B64D 27/35; H02M 1/00; H02M 7/5387

(52) U.S. Cl. CPC H02M 7/49; B64D 27/35; H02M 1/0038; H02M 7/53871; B64D 2221/00

(57) ABSTRACT

This power conversion device outputs AC voltages for three phases, each voltage of three phases being obtained by adding an output of a sub inverter to an output of a main inverter capable of outputting three levels of voltages E, 0, and −E. Voltages of power storage elements for supplying bus voltages for the sub inverter are controlled to be E/3. As target AC voltages of the output voltages for the respective phases, third-order superimposed target AC voltages each obtained by adding, to a target AC voltage of a corresponding fundamental wave, a corresponding third-order superimposition voltage as a third-order harmonic having a frequency that is 3 times a frequency of the fundamental wave are set. An amplitude of each third-order superimposition voltage is set such that a fundamental wave component included in a corresponding output voltage of the sub inverter becomes 0.

### TECHNICAL FIELD

The present disclosure relates to an electric power conversion device and a flying object provided therewith.

### BACKGROUND ART

In recent years, electrification systems such as electric automobiles or motor-driving from engines in ships and the like have been progressively spreading. Furthermore, regarding aircraft as well, research for electrification has been progressing in various countries throughout the world in view of the trend of reducing CO₂. Devices to be mounted in aircraft are required to have low weights. As a matter of course, power conversion devices such as motor-driving inverters and power supplies for equipment to be mounted in aircraft are also required to be devices having higher efficiencies and lower weights. Out of these devices, inverters for driving propulsion AC motors requiring a large amount of power in the power conversion devices particularly require application of technologies for causing the inverters to become devices having lower weights, as described above.

Inverter devices to be mounted in aircraft are required to have low weights, and meanwhile, the outputs of the inverter devices sometimes influence the load side. Wires are present between each of the inverters and a motor as a load corresponding to the inverter, and, when an output voltage having a steep rise is outputted from the inverter, a surge voltage is superimposed on the output. The surge voltage causes a partial discharge phenomenon to occur, through a dielectric, at a winding end portion of the motor or between the wires. The partial discharge phenomenon results in degradation of each part. In a high-altitude environment as in an aircraft, the atmospheric pressure is low, and thus electric discharge more easily occurs than on the ground, whereby a countermeasure needs to be taken at a higher level than a countermeasure taken for an apparatus for use on the ground.

A filter needs to be mounted as in Non-Patent Document 1 in order to suppress surge. The filter is a heavy object, and the weight thereof is about half the weight of the device. Thus, the filter hinders reduction in weight. A multilevel inverter involves a useful topology for downsizing such a filter.

Examples of the multilevel inverter topology as an effective circuit type include a series-multiplex-type multilevel inverter such as one in Patent Document 1. In the series-multiplex-type multilevel inverter, each of main inverters with a high voltage and a low frequency and a sub inverter with a low voltage and a high frequency are connected in series, and the total value of the output voltages of these respective inverters is outputted from the power conversion device. Hereinafter, this inverter is referred to as “gradationally controlled inverter”.

### CITATION LIST

### Patent Document

Patent Document 1: WO2020-166003

Patent Document 2: Japanese Laid-Open Patent Publication No. 2012-175848

### Non-Patent Document

Non-Patent Document 1: Arie Nawawi, et al. “Design and Demonstration of High Power Density Inverter for Aircraft Applications” IEEE Transactions on Industry Applications, Volume: 53, Issue: 2, March-April 2017

### SUMMARY OF THE INVENTION

### Problem to be Solved by the Invention

A voltage is necessary for a DC bus of the sub inverter of the gradationally controlled inverter. In terms of cost and size, it is difficult to separately prepare a DC power supply in order to ensure this voltage. Considering this, the main inverter may bear the entire output power, and the output power of the sub inverter may be set to zero in one cycle of output AC. Consequently, elimination of the need for a power supply can be realized. Patent Document 2 discloses a means for realizing this elimination of the need for a power supply.

According to Patent Document 2, output power is adjusted by means of advancing or delaying the phases of output pulses of the respective inverters, whereby elimination of the need for a power supply described above can be realized. However, Patent Document 2 relates to a technology intended for a reactive power compensation device as an inverter that handles reactive power with respect to a power grid having a fixed output AC voltage and a fixed frequency within specific ranges. Thus, Patent Document 2 is not suitable for an application in which neither the output AC voltage nor the frequency is fixed, and in particular, active power is used, as in propulsion-related motor drive in an aircraft.

An object of the present disclosure is to provide a power conversion device that includes main inverters and sub inverters and that is applicable to a use in which neither the output AC voltage nor the frequency is fixed, the power conversion device being capable of realizing elimination of the need for a power supply for each of the sub inverters, the power conversion device allowing suppression of partial discharge in a load and having a low weight.

### Means to Solve the Problem

A power conversion device according to the present disclosure includes: three main inverters each of which generates any of a DC voltage E, a DC voltage −E, and a voltage of 0 as an output voltage through switching among E, −E, and 0 by a plurality of semiconductor switching elements connected in series, the three main inverters respectively being a U-phase main inverter, a V-phase main inverter, and a W-phase main inverter each having an output terminal; three sub inverters each of which has a plurality of semiconductor switching elements and a power storage element for supplying a DC voltage Vb and each of which generates any of Vb, −Vb, and the voltage of 0 as an output voltage through switching among Vb, −Vb, and 0, the three sub inverters respectively being a U-phase sub inverter, a V-phase sub inverter, and a W-phase sub inverter which are respectively connected to the output terminal of the U-phase main inverter, the output terminal of the V-phase main inverter, and the output terminal of the W-phase main inverter such that a voltage obtained by adding the output voltage of the sub inverter for each of the phases to the output voltage of the main inverter for the phase becomes an output voltage for the phase, to allow AC voltages for the three phases to be outputted; and a controller which controls the plurality of semiconductor switching elements in each of the three main inverters and the plurality of semiconductor switching elements in each of the three sub inverters.

The controller sets a target voltage of the voltage Vb of the capacitor for each of the phases to E/3. The controller sets, as target AC voltages of the output voltages for the respective phases, third-order superimposed target AC voltages each obtained by adding, to a fundamental wave target AC voltage as a target AC voltage of a corresponding target fundamental wave, a corresponding third-order superimposition voltage as a third-order harmonic having a frequency that is 3 times a frequency of the fundamental wave. The controller sets an amplitude of each of the third-order superimposition voltages such that a fundamental wave component included in the output voltage of the sub inverter for the corresponding phase becomes 0. The controller controls the semiconductor switching elements in each of the main inverters for the respective phases and the semiconductor switching elements in each of the sub inverters for the respective phases.

### Effect of the Invention

The present disclosure makes it possible to provide a power conversion device that includes main inverters and sub inverters and that is applicable to a use in which neither the output AC voltage nor the frequency is fixed, the power conversion device being capable of realizing elimination of the need for a power supply for each of the sub inverters, the power conversion device allowing suppression of partial discharge in a load and having a low weight.

### BRIEF DESCRIPTION OF THE DRAWINGS

FIG. 1 is a circuit diagram showing a configuration of a power conversion device according to embodiment 1.

FIG. 2 is a diagram regarding the power conversion device according to embodiment 1, for explaining output voltages of a main inverter, a sub inverter, and the power conversion device.

FIG. 3 is a chart for explaining a basic operation of a gradationally controlled inverter.

FIG. 4 is a chart for explaining an operation of the power conversion device according to embodiment 1.

FIG. 5 shows a graph for explaining a method for determining a phase for rising of an output pulse of the main inverter, in one example of the operation of the power conversion device according to embodiment 1.

FIG. 6 is a chart for explaining a second operation example of the power conversion device according to embodiment 1.

FIG. 7 is a chart for explaining a third operation example of the power conversion device according to embodiment 1.

FIG. 8 shows a graph for explaining a method for determining a phase for rising of the output pulse of the main inverter, in another example of the operation of the power conversion device according to embodiment 1.

FIG. 9 shows a graph for explaining a method for determining a phase for rising of the output pulse of the main inverter, in still another example of the operation of the power conversion device according to embodiment 1.

FIG. 10 shows, as graphs having a horizontal axis indicating third-order superimposition voltage amplitude B, values each of which is a ratio b_{b1}/A of a fundamental wave component b_{b1} of the sub inverter to a target AC voltage amplitude A and among which the target AC voltage amplitude A varies, in the power conversion device according to embodiment 1.

FIG. 11 shows some of the graphs that are extracted from FIG. 10 in order to explain an operation of the power conversion device according to embodiment 1.

FIG. 12 is a diagram obtained by adding arrows indicating directionality of control to the graphs in FIG. 11 in order to explain the operation of the power conversion device according to embodiment 1.

FIG. 13 is a block diagram for explaining calculation in a controller of the power conversion device according to embodiment 1.

FIG. 14 is a block diagram for explaining calculation in a controller of a power conversion device according to embodiment 2.

FIG. 15 is a block diagram for explaining calculation in a controller of a power conversion device according to embodiment 3.

FIG. 16 is a diagram for explaining a resetting operation in the controller of the power conversion device according to embodiment 3.

FIG. 17 is a schematic circuit diagram showing another example of the configuration of the main inverter in each of the embodiments.

FIG. 18 is a block diagram showing an example of the configuration of the controller 11 in each of the embodiments.

FIG. 19 is a block diagram showing a schematic configuration of a flying object according to embodiment 4.

### DESCRIPTION OF EMBODIMENTS

### Embodiment 1

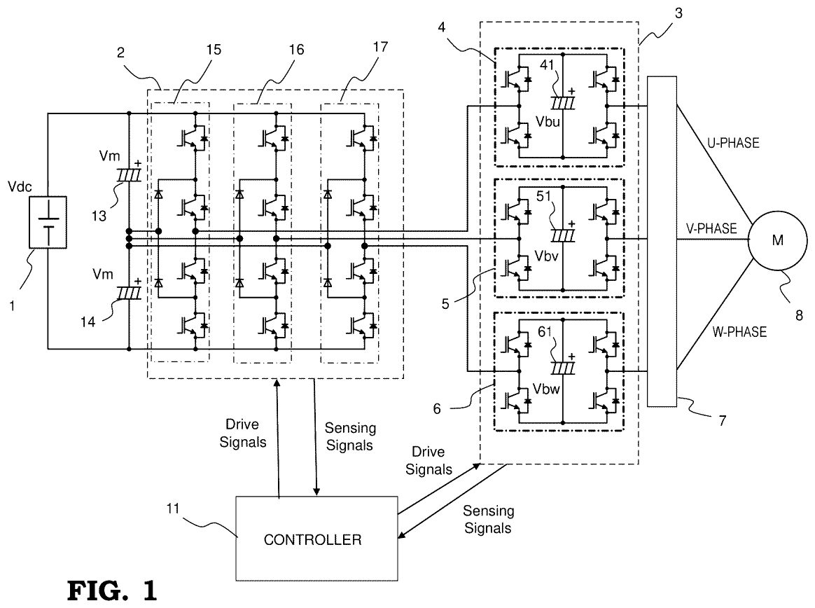

Hereinafter, a power conversion device according to embodiment 1 will be described with reference to the drawings. FIG. 1 is a circuit diagram showing a configuration of the power conversion device according to embodiment 1. The power conversion device converts DC of a DC source 1 into AC that is necessary for driving a motor 8 as a load. In the present embodiment, the DC source 1 is assumed to supply power through DC power distribution in an aircraft. Alternatively, the DC source 1 may be an ordinary DC power supply or a cell system such as a solar cell. The power conversion device which is a gradationally controlled inverter is composed of a main inverter 2, a sub inverter 3, and a controller 11 which controls these inverters. Outputs of the gradationally controlled inverter are supplied via a filter 7 to the motor 8 as a load.

The main inverter 2 is a three-phase inverter and is, as shown in FIG. 1, a three-level inverter that can output, in each of the phases, three levels of potentials which are the potential on the positive side (high-potential side) of the DC source 1, the potential on the negative side (low-potential side) of the DC source 1, and the potential, at a neutral point, as a median value between the potential on the positive side and the potential on the negative side. The three-level inverter shown in FIG. 1 is composed of three output phases formed by a U-phase main inverter arm 15 (also simply referred to as “U-phase main inverter 15”), a V-phase main inverter arm 16 (also simply referred to as “V-phase main inverter 16”), and a W-phase main inverter arm 17 (also simply referred to as “W-phase main inverter 17”). The three-level inverter includes, in each of the phases, semiconductor switching elements implemented by four self-turn-off semiconductor elements such as IGBTs or MOSFETs each having switching ability and two diodes each having rectification ability.

The U-phase main inverter 15, the V-phase main inverter 16, and the W-phase main inverter 17 of the main inverter 2 have respective output terminals to which respective sub inverters are connected in series. The sub inverters form the sub inverter 3 and are for the respective phases. Each of the sub inverters for the respective phases is a full-bridge inverter composed of two phases of inverter arms and includes, in each of these two phases, semiconductor switching elements implemented by two self-turn-off semiconductor switching elements such as IGBTs or MOSFETs each having switching ability. The sub inverters for the respective phases are referred to as a U-phase sub inverter 4, a V-phase sub inverter 5, and a W-phase sub inverter 6. Here, capacitors that are power storage elements are used as DC sources for supplying DC bus voltages for the respective sub inverters. That is, a U-phase capacitor 41 is provided as a DC source for the U-phase sub inverter 4, a V-phase capacitor 51 is provided as a DC source for the V-phase sub inverter 5, and a W-phase capacitor 61 is provided as a DC source for the W-phase inverter. As the above DC sources for the respective sub inverters, power storage elements other than capacitors such as lithium-ion batteries can also be used.

Switching of the semiconductor switching elements as parts of the main inverter 2 and the sub inverter 3 is controlled by the controller 11 which controls the waveforms of output voltages, and a gate of each of the semiconductor switching elements is driven through a driver. In addition, a sensor detects: a high-potential-side voltage (a voltage of a P bus capacitor 13) and a low-potential-side voltage (a voltage of an N bus capacitor 14) which are input-side voltages of the main inverter 2; and a voltage Vbu of the U-phase capacitor 41, a voltage Vbv of the V-phase capacitor 51, and a voltage Vbw of the W-phase capacitor 61 which are bus voltages for the respective three phases in the sub inverter 3.

A DC bus voltage Vdc of the main inverter 2 is a voltage of the DC source 1. Since the main inverter 2 is a three-level inverter, the DC bus voltage Vdc is divided at a neutral point by the two capacitors connected in series. The P bus capacitor 13 and the N bus capacitor 14 are respectively connected to the high-potential side and the low-potential side, and each of the voltages of the P bus capacitor 13 and the N bus capacitor 14 is controlled to be Vm=Vdc/2.

The DC bus voltages Vbu, Vbv, and Vbw (which are controlled as the same target voltage, and thus are sometimes referred to as “Vb” indicating a common voltage) which are voltages of the capacitors for the respective phases in the sub inverter 3 are lower than Vm, which is each of the high-potential-side and low-potential-side voltages as the inputs of the main inverter 2, and are controlled to be one-third of Vm. Therefore, when the voltage level of Vdc is defined as 2E, the voltage level of Vb is E/3.

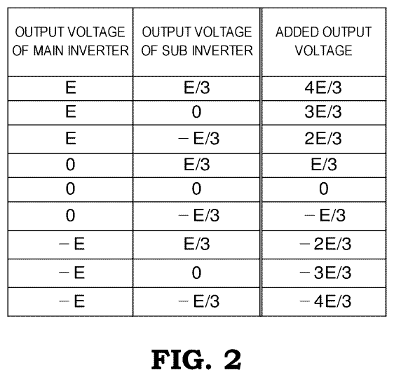

Each of the outputs of the main inverter 2 and the corresponding output of the sub inverter 3 are added up in series, and the resultant sum is outputted, whereby a multilevel waveform similar to the waveform of a sine wave can be outputted. FIG. 2 is a table indicating a list of output voltages of the main inverter 2, output voltages of the sub inverter 3, and output voltages of the gradationally controlled inverter each obtained by adding up both the corresponding output voltage of the main inverter 2 and the corresponding output voltage of the sub inverter 3. The main inverter 2 has three output patterns which are E, 0, and −E, and the sub inverter has three output patterns which are E/3, 0, and −E/3. This indicates that a ternary gradationally controlled inverter for outputting a continuous output voltage in nine voltage levels with each of the differences therebetween being E/3 is realized. Since a continuous output voltage is outputted in nine voltage levels with each of the differences therebetween being E/3, the surge voltage is low, and a filter having a low weight can be used as the filter. The voltage level of the sub inverter, i.e., the voltage controlled as Vb, does not have to be accurately one-third of E and only has to be controlled within, for example, a range from 0.9×E/3 to 1.1×E/3. Even when Vb slightly deviates from one-third of E, the error in waveform can be corrected through switching control, and, regarding the filter, the error falls within a range based on a reactor design, whereby the advantageous effect of the present disclosure can be exhibited.

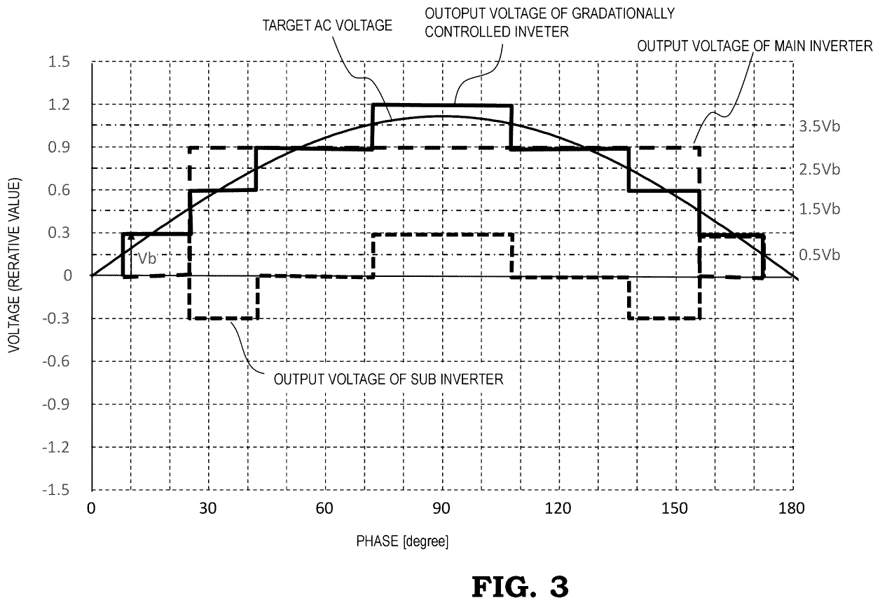

FIG. 3 shows one example of an output voltage in a basic operation of the gradationally controlled inverter. Only the positive side of a sine wave is extracted. Regarding the phase on the negative side as well, the output voltage takes a similar waveform that differs only in that the polarity thereof is opposite to the polarity on the positive side. The horizontal axis indicates phase, and the vertical axis indicates voltage.

The start point is a phase of 0 degrees.

When a target waveform takes a value larger than 0.5Vb, only the sub inverter 3 is operated so as to output +E/3.

Next, when the target waveform takes a value larger than 1.5Vb, the main inverter 2 and the sub inverter 3 respectively output +E and −E/3, whereby a total of 2E/3 is outputted.

Next, when the target waveform takes a value larger than 2.5Vb, the main inverter 2 and the sub inverter 3 respectively output +E and 0, whereby a total of 3E/3 is outputted.

Next, when the target waveform takes a value larger than 3.5Vb, the main inverter 2 and the sub inverter 3 respectively output +E and +E/3, whereby a total of 4E/3 is outputted.

Next, when the target waveform takes a value smaller than 3.5Vb, the main inverter 2 and the sub inverter 3 respectively output +E and 0, whereby a total of 3E/3 is outputted.

Next, when the target waveform takes a value smaller than 2.5Vb, the main inverter 2 and the sub inverter 3 respectively output E and −E/3, whereby a total of 2E/3 is Outputted.

Next, when the target waveform takes a value smaller than 1.5Vb, only the sub inverter 3 is operated so as to output +E/3.

Lastly, when the target waveform takes a value smaller than 0.5Vb, each of the main inverter and the sub inverter outputs 0, whereby a total of 0 is outputted. Then, the target waveform reaches a phase of 180 degrees.

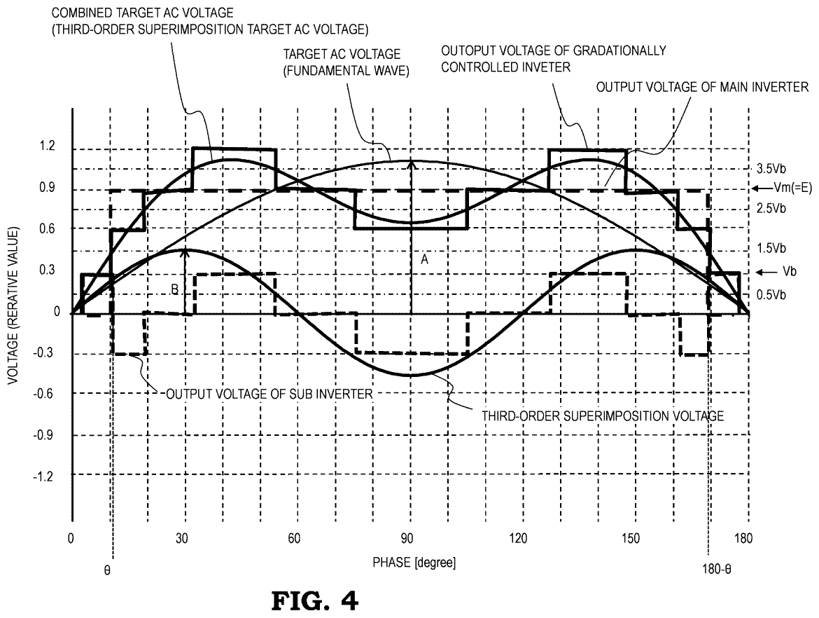

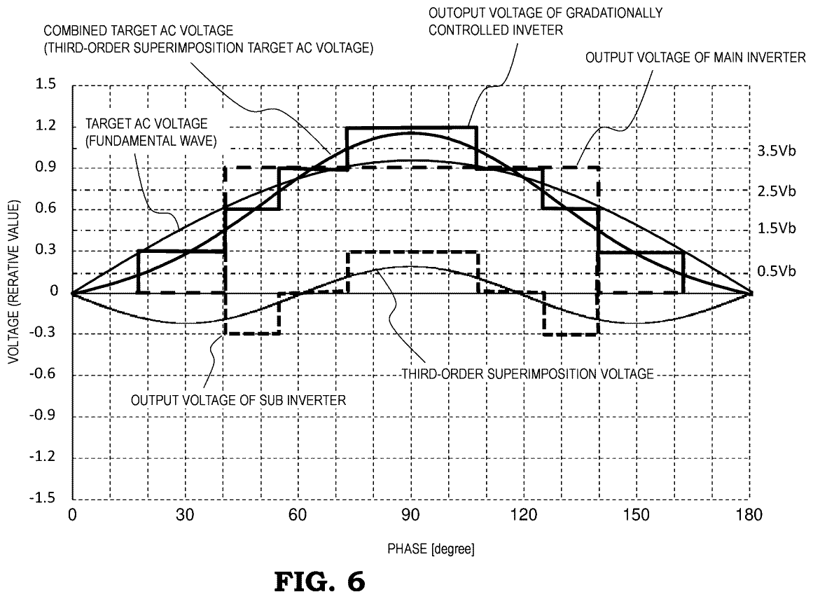

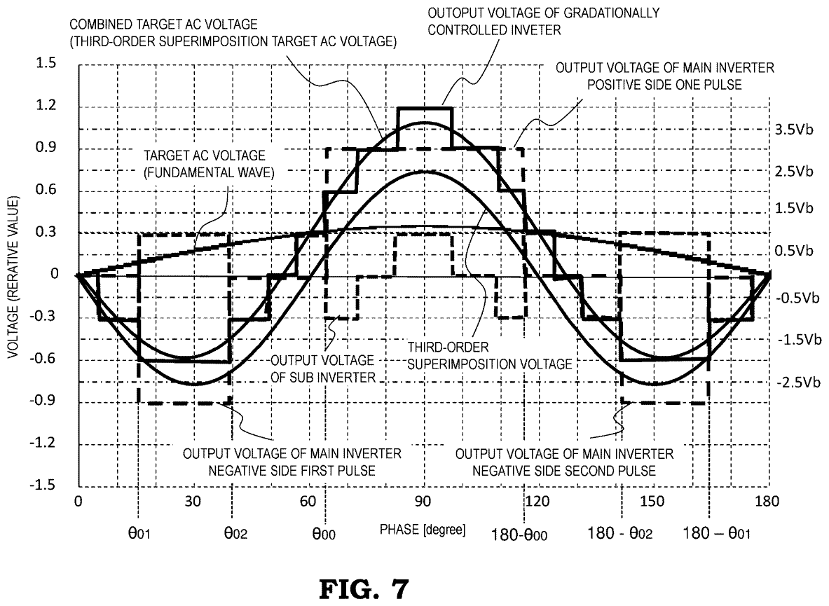

Consequently, a simulative sine wave is formed on the positive side. In the present disclosure, each of the output voltages of the main inverter 2 and the corresponding output voltage of the sub inverter 3 are added up, and a target waveform of a sine wave or the like is simulatively realized in the form of a stepwise output voltage waveform that is changed by E/3 (=Vb) per step. In this manner, in order to simulatively realize a target waveform in the form of a stepwise output voltage waveform that is changed by E/3 (=Vb) per step, outputting from the main inverter 2 only has to be started and stopped at respective phases that are time points at which the target waveform takes the value of 1.5Vb. The respective time points (phases) at which outputting from the main inverter 2 is started and stopped apply also to FIG. 4, FIG. 6, and FIG. 7 described later. The same applies also to the negative side except that the sign of polarity is opposite to the sign on the positive side. That is, outputting from the main inverter 2 only has to be started and stopped at respective phases that are time points at which the target waveform takes the value of −1.5Vb.

Here, the capacitor voltage Vb as a DC source for applying the DC bus voltage of the sub inverter 3 needs to be controlled to be E/3. Since no dedicated power supply is provided, the output power of the sub inverter 3 needs to be set to 0 as a whole in a power supply cycle in order to maintain the capacitor voltage Vb of the sub inverter 3 at E/3. Since the sub inverter 3 gives an output having a different polarity per half the power supply cycle as in FIG. 3, the amount of power during the period in which the polarity is positive and the amount of power during the period in which the polarity is negative only have to be made equal to each other. Considering this, in order to make the amounts of power equal to each other, the amounts of power at the respective positive and negative polarities in the sub inverter 3 are adjusted, and this operation means that the main inverter 2 bears the entire AC output. Therefore, said adjustment only involves control of the phase period in which rising occurs in the main inverter 2.

Here, as shown in FIG. 3, the output of the sub inverter 3 in the ternary gradationally controlled inverter includes a third-order harmonic component having a frequency that is 3 times the frequency of a sine wave (fundamental wave). Considering this, in the present embodiment, a target AC voltage to be outputted by the gradationally controlled inverter is obtained as follows. That is, a third-order harmonic having an adjusted amplitude (also referred to as “third-order superimposition voltage”) is superimposed on a target AC voltage of the fundamental wave (fundamental wave target AC voltage), and the maximum voltage is adjusted, whereby power adjustment is performed, i.e., the period for outputting from the main inverter 2 is adjusted. The output for each of the U, V, and W phases includes a third-order harmonic, and meanwhile, an interphase voltage includes only a fundamental wave component as a result of cancellation of a third-order harmonic. When the third-order harmonic has not been completely canceled in the interphase voltage, the frequency of the third-order harmonic does not have to be accurately 3 times the frequency of the fundamental wave as long as no problem arises in terms of a waveform distortion of the interphase voltage. For example, with the interphase voltage including a component having a frequency that is 3 times the frequency of the fundamental wave component, within such a range that the percentage of the included component to the fundamental wave component is equal to or lower than a percentage defined in a harmonic standard that needs to be complied with in an application, the frequency of the third-order harmonic may deviate from the frequency that is 3 times the frequency of the fundamental wave. The frequency of the third-order harmonic only has to fall within, for example, a range from 2.9 times to 3.1 times the frequency of the fundamental wave. FIG. 4 shows one example of voltage waveforms obtained when a third-order harmonic is added to the fundamental wave target AC voltage so as to obtain a third-order superimposed target AC voltage as a target AC voltage of the gradationally controlled inverter. In comparison between FIG. 3 and FIG. 4, it is seen that the phase and the period of outputting of a voltage from the main inverter 2 are changed. When the third-order harmonic shown in FIG. 4 is superimposed, the period of outputting from the main inverter 2 is longer than that in FIG. 3, whereby the output power of the main inverter 2 is increased. In the present embodiment, the direction of increase/decrease in power and the amount of increase/decrease in power are changed according to the polarity and the magnitude of the third-order harmonic to be superimposed.

The period of outputting from the main inverter 2 will be described. Firstly, three patterns of periods of outputting from the main inverter 2 are present according to a target AC voltage amplitude A of the fundamental wave and an amplitude (referred to as “third-order superimposition voltage amplitude”) B of the third-order harmonic to be added, i.e., the third-order superimposition voltage. In order to simplify mathematical expressions, the DC bus voltage of the sub inverter 3 (the voltage of the capacitor in the sub inverter 3) is represented by Vb (=E/3), and the voltage of the main inverter 2 is represented by Vm (=E).

A first main pattern is a pattern in which the amplitude polarity of the third-order harmonic is set to be the same as the amplitude polarity of the fundamental wave. At this time, a target voltage Vr is expressed by expression (1).

Vr=Asinθ+Bsin3θ (1)

Here, expression (2) is satisfied in relation to a phase θ₀ at which the main inverter starts outputting.

Vm/2=1.5Vb=(A+3B)sinθ₀−4Bsin³θ₀ (2)

Furthermore, when sin00 is substituted with X, expression (3) is satisfied.

4BX³−(A+3B)×+1.5Vb=0 (3)

Solutions to the cubic equation in expression (3) are X1, X2, and X3 respectively expressed by expression (4), expression (5), and expression (6).

X1=(−27a₀a₃²+L·i))^{1/3}/(3(2)^{1/3}a₃)−(2)^{1/3}a₁/(−27a0a₃²+L·i)^{1/3} (4)

X2=ω(−27a₀a₃²+L·i))^{1/3}/(3(2)^{1/3}a₃)−ω²(2)^{1/3}a₁/(−27a0a₃²+L·i)^{1/3} (5)

X3=ω²(−27a₀a₃²+L·i)^{1/3}/(3(2)^{1/3}a₃)−ω(2)^{1/3}a₁/(−27a0a₃²+L·i)^{1/3} (6)

In these expressions, a₀=1.5Vb, a₁=−(A+3B), a₃=4B, L=(−4·27(a₁a₃)³−(27a₀a₃²)²)^{1/2}, i=√(−1), and ω=−½+(√(3)/2)i are satisfied.

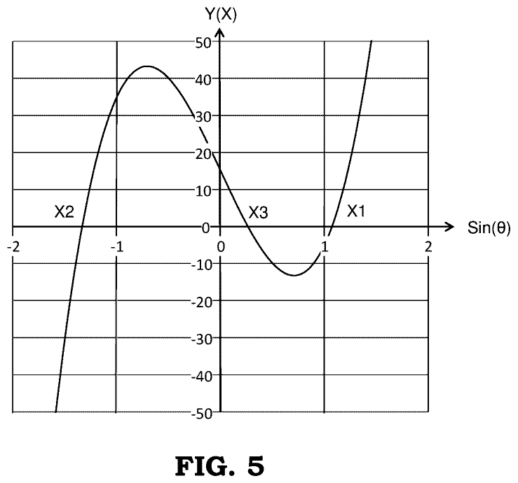

A graph is shown in FIG. 5 as an example. In the graph, the left-hand side of expression (3) is set as a function Y(X) with A being set to 30, B being set to 10, Vb being set to 10, and Vm being set to 30. Results with which the value of the function becomes 0 are X1 to X3. Among these solutions, the only solution within a range from 0 to 1 as sinθ is X3, a phase at which sinθ becomes X3 is a phase θ at which rising occurs in the main inverter 2, and falling occurs at 180 degrees−θ.

A second main pattern is a pattern in which: the amplitude polarity of the third-order harmonic is opposite (with B being negative) to the amplitude polarity of the fundamental wave; and, as an output pulse of the main inverter 2, only one pulse is generated on one polarity side. FIG. 6 shows an example of this waveform. Solutions in the second main pattern are obtained according to expression (4), expression (5), and expression (6) in the same manner as in the first main pattern.

A third main pattern is a pattern in which: the amplitude polarity of the third-order harmonic is opposite (with B being negative) to the amplitude polarity of the fundamental wave; and, as output pulses of the main inverter 2, one pulse is generated on the positive side and two pulses are generated on the opposite polarity side (negative side). FIG. 7 shows an example of this waveform. Regarding the pulse on the positive side, solutions are obtained according to expression (4), expression (5), and expression (6) in the same manner as in the first main pattern. Regarding the pulses on the opposite polarity side, solutions can be obtained according to expression (4), expression (5), and expression (6) by changing a₀ to −Vm/2.

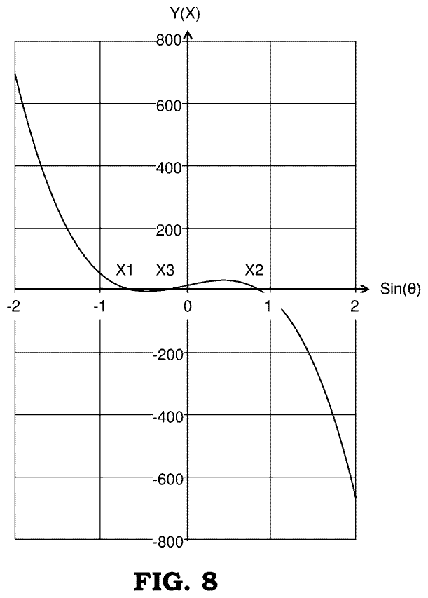

A graph is shown in FIG. 8 as an example of the output pulse on the positive side of the main inverter 2. In the graph, the left-hand side of expression (3) is set as a function Y(X) with A being set to 10, B being set to −25, Vb being set to 10, Vm being set to 30, and a₀ being set to Vm/2. Variables X with which the function Y(X) becomes 0 are solutions which are X1 to X3. Here, the only solution within a range from 0 to 1 as sinθ is X2, a phase at which sinθ becomes X2 is a phase θ₀₀ at which rising occurs in the main inverter, and falling occurs at 180 degrees−θ₀₀.

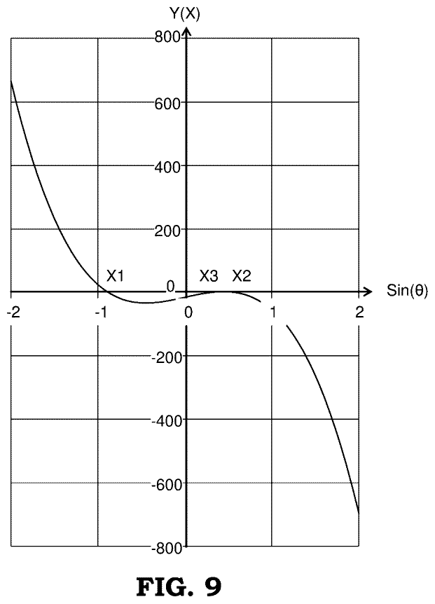

Likewise, a graph is shown in FIG. 9 as an example of the output pulse on the negative side of the main inverter 2. In the graph, expression (3) is set as a function Y(X) with A being set to 10, B being set to −25, Vb being set to 10, Vm being set to 30, and a₀ being set to −Vm/2. Variables X with which the function Y(X) becomes 0 are solutions which are X1 to X3. Here, solutions within a range from 0 to 1 as sinθ are X2 and X3. From the side close to said sinθ₀, a phase at which sinθ becomes X3 is a phase θ₀₁ at which rising to the negative side occurs in the main inverter, and a phase θ₀₂ at which sinθ becomes X2 is a phase at which falling occurs in the main inverter. Regarding second negative output pulses, values obtained by subtracting the above θ₀₁ and θ₀₂ from 180 degrees respectively correspond to the phase at which falling occurs and the phase at which rising occurs.

Next, a third-order superimposition voltage amplitude B of a third-order superimposition voltage as a third-order harmonic to be superimposed is obtained. Firstly, a fundamental wave component bₘ₁ which is included in the output voltage of the main inverter 2 and which is an odd function is expressed by expression (7) through Fourier series expansion.

bₘ₁=(4Vm/π)·(cosθ₀₀+cosθ₀₂−cosθ₀₁) (7)

The fundamental wave component bₘ₁ of the main inverter 2 and a fundamental wave component b_{b1} included in the output voltage of the sub inverter 3 are in a relationship expressed by expression (8) with respect to the target AC voltage amplitude A.

A=bₘ₁+b_{b1} (8)

Therefore, the fundamental wave component b_{b1} of the sub inverter 3 is obtained according to expression (9).

b_{b1}=A−bₘ₁=A−(4Vm/π)·(cosθ₀₀+cosθ₀₂−cosθ₀₁) (9)

Setting the total power of the sub inverter 3 to 0 is a prerequisite for voltage stabilization. Thus, when the calculation result of the above expression (9) indicating the fundamental wave component is 0, no power is generated in the sub inverter 3, and the DC bus voltage of the sub inverter is stable.

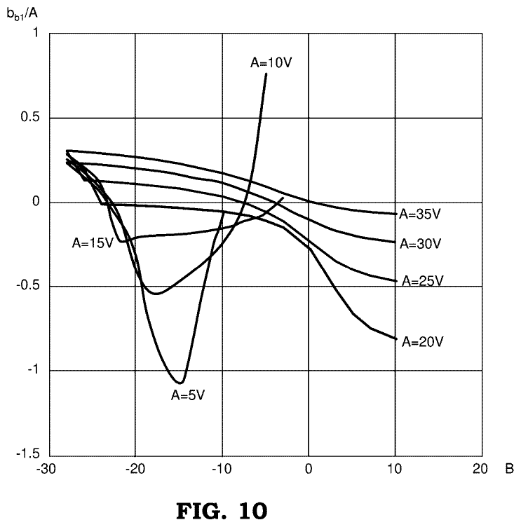

FIG. 10 shows the value of b_{b1}/A as the ratio of the fundamental wave component b_{b1} of the sub inverter 3 to the target AC voltage amplitude A with the third-order superimposition voltage amplitude B being indicated by the horizontal axis and with the target AC voltage amplitude A being regarded as a parameter when, for example, the bus voltage Vm of the main inverter 2 is set to 30 V and the bus voltage Vb of the sub inverter 3 is set to 10 V. FIG. 10 shows graphs among which the target AC voltage amplitude A varies from 5 V to 35 V.

In each of the graphs in FIG. 10, a point at which b_{b1}/A intersects with the zero line is present. That is, when control can be performed to add a third-order superimposition voltage such that operation occurs at the intersection with the zero line, the fundamental wave component b_{b1} included in the output voltage of the sub inverter 3 can be set to 0, i.e., the amount of energy that is caused to flow into or flow out from the sub inverter can be set to zero. Consequently, the bus voltage Vb of the sub inverter 3 can be stabilized. That is, the main inverters and the sub inverters only have to be controlled by: obtaining, with respect to a target AC voltage amplitude A, each third-order superimposition voltage amplitude B at which the fundamental wave component b_{b1} included in the output voltage of the sub inverter for the corresponding phase becomes 0; adding the third-order superimposition voltage having the obtained third-order superimposition voltage amplitude B to the corresponding fundamental wave target AC voltage having the target AC voltage amplitude A, to obtain a voltage; and setting the voltage as the corresponding third-order superimposed target AC voltage.

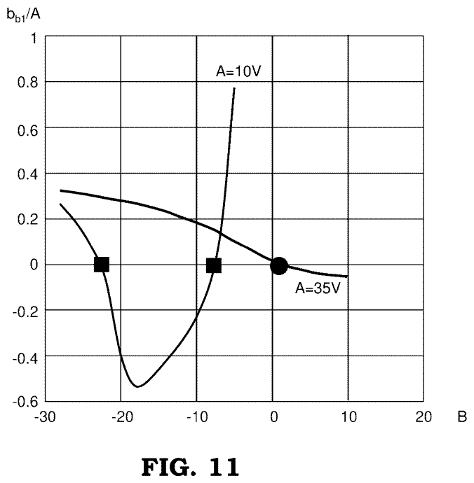

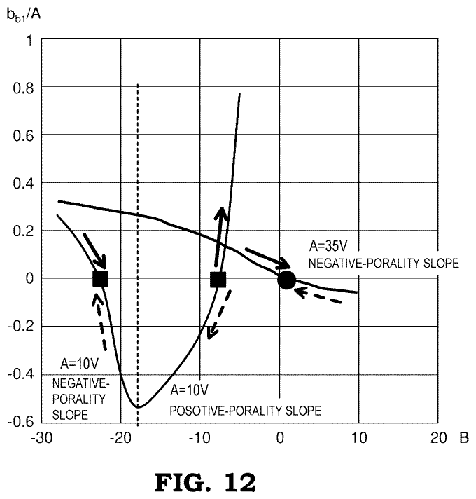

FIG. 11 shows a waveform obtained when the target AC voltage amplitude A is 35 V and a waveform obtained when A is 10 V, the waveforms being extracted from FIG. 10. As shown in the drawing, when A is 35 V, the slope of b_{b1}/A as the ratio of the fundamental wave component b_{b1} of the sub inverter 3 to the target AC voltage amplitude A is a negative slope alone and has one intersection with the zero line. Meanwhile, when A is 10 V, the slope of b_{b1}/A as the ratio of the fundamental wave component b_{b1} of the sub inverter 3 to the target AC voltage amplitude A has an extremum as a point of change from a negative slope to a positive slope and has two intersections with the zero line. At the intersection located on the right side out of the two intersections, the slope of b_{b1}/A relative to a control amount is opposite to the slope at the intersection located on the left side. FIG. 12 is obtained by additionally drawing, in FIG. 11, arrows indicating the directionality of control.

According to FIG. 12, for arrival at each of the intersections, the direction of increase/decrease in the magnitude of the amplitude of the third-order superimposition voltage that is to be superimposed and that is necessary for controlling the bus voltage Vb of the sub inverter 3 to be a target value is reversed with respect to the polarity of a deviation of the bus voltage Vb. Therefore, directions in a condition of change in the control amount relative to the deviation should be set to be the same as each other in the case of calculating, by the controller 11, a third-order superimposition voltage amplitude B of the third-order superimposition voltage as a third-order harmonic for controlling the bus voltage Vb of the sub inverter 3.

In this case, even under a condition in which two intersections are present, only an intersection with which the control direction becomes the same as a control direction obtained under a condition that only one intersection is present is used. In order to cause the control directions to match, a third-order superimposition limiter which is an upper-limit limiter needs to be provided, as a prohibition region, to the third-order superimposition voltage amplitude B so as to prevent arrival at a positive slope, such that the control system does not achieve arrival at the intersection located on the right side.

An appropriate range of the value of this limiter is equal to or larger than a third-order superimposition voltage amplitude B, as a solution, at the intersection located on the left side (low-voltage side) and is equal to or smaller than a third-order superimposition voltage amplitude B at an extremum as a point of change in the orientation of the slope. For each of conditions for the target AC voltage amplitude A in the present embodiment, when one intersection is present, the intersection is obtained, and, when two intersections are present, the extremum as a point of change in the slope is obtained. Then, an approximation expression with the target AC voltage amplitude A being a change amount (variable) is formulated from the plotted values, and the approximation expression is used in the controller 11. Thus, the controller 11 performs calculation on the approximation expression in a control routine. A margin may be provided to each of the plotted values such that: when one intersection is present, the plotted value is larger than the value at the intersection; and, when two intersections are present, the plotted value is smaller than the value at the extremum.

Also, when the third-order superimposition voltage amplitude B has a small value also at the intersection on the right side as indicated in FIG. 12 by the graph obtained under the condition that the target AC voltage amplitude A is 10 V, an intended slope is changed from a positive-polarity slope to a negative-polarity slope although deviation in control temporarily occurs. Thus, a limiter for the third-order superimposition voltage amplitude B can also be set in the case of a value smaller than the value at the intersection on the positive-polarity side.

As a matter of course, the operation of the controller 11 can be realized also through, instead of a method that includes performing complicated calculation on a function each time, a method that includes: obtaining solutions to an approximation expression in advance; creating a map by using a list of the results as limiter values; saving the map in a memory; and reading the map during a control routine.

The above description is summarized as follows. That is, when a target AC voltage amplitude A is given, each third-order superimposition voltage amplitude B at which the corresponding fundamental wave component b_{b1} of the sub inverter 3 becomes 0 is obtained with respect to said A by using an approximation expression or a map stored in the controller 11. Then, from a solution to expression (3), the phase at which the pulse of the main inverter 2 rises and the phase at which the pulse of the main inverter 2 falls are obtained, and the phase at which the pulse of the sub inverter rises and the phase at which the pulse of the sub inverter falls are obtained. Then, each of the semiconductor switching elements is controlled. By thus performing control, an AC voltage obtained by superimposing a third-order superimposition voltage onto a fundamental wave can be outputted as an output for each of the U, V, and W phases in the gradationally controlled inverter, and, as an interphase voltage, a three-phase AC voltage in which a third-order superimposition voltage has been canceled can be generated. At this time, the total power of the sub inverter 3 in one cycle is 0. In addition, the target voltage of the voltage Vb of each of the capacitors in the sub inverter 3 is set to E/3. Phases at which the pulse of the sub inverter rises and phases at which the pulse of the sub inverter falls are determined as phases at which the third-order superimposed target AC voltage becomes E/3, 2E/3, 0, −E/3, and −2E/3.

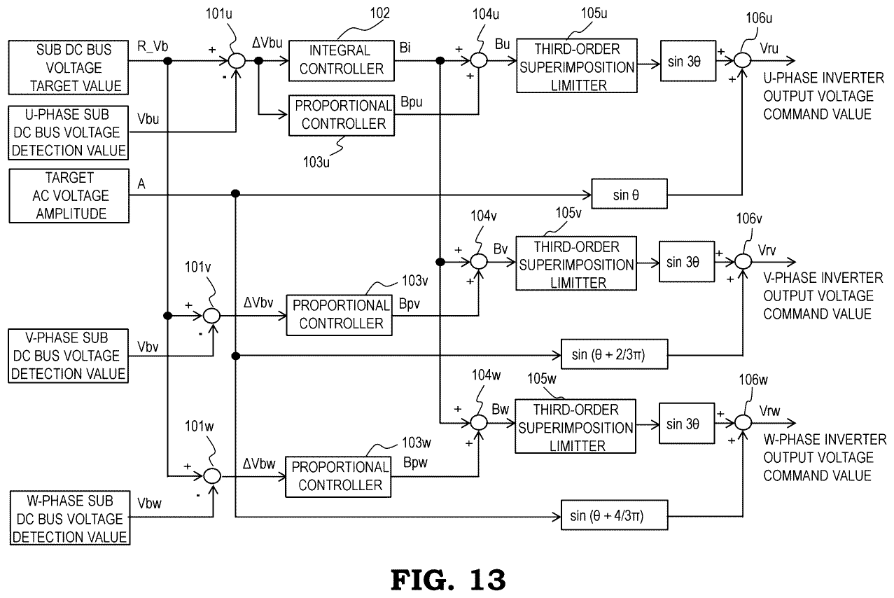

FIG. 13 is a block diagram for explaining calculation for obtaining third-order superimposition voltage amplitudes B of third-order harmonics to be superimposed and inverter output voltage command values Vr (Vru, Vrv, and Vrw) which are third-order superimposed target AC voltages for the U, V, and W phases, in the controller 11 of the power conversion device according to embodiment 1.

First, calculation is performed with the U phase being a reference. A subtractor 101u calculates a deviation ΔVbu (also referred to as “first deviation”) between: a sub DC bus voltage target value (a target value of the voltage of each of the capacitors) R_Vb which is a sub inverter DC bus voltage target value of the sub inverter 3; and a U-phase sub DC bus detection value Vbu which is a detection value of the sub inverter bus voltage for the U phase, i.e., the voltage of the capacitor for the U phase. The deviation ΔVbu is inputted to an integral controller 102 which is then used to calculate a control amount Bi as an output thereof. In addition, the deviation ΔVbu is inputted to a U-phase proportional controller 103u which is then used to calculate a control amount Bpu as an output thereof. An adder 104u adds up: the control amount Bi which is the output of the integral controller 102; and the U-phase control amount Bpu which is the output of the U-phase proportional controller 103u. The resultant sum is a third-order superimposition voltage amplitude Bu in the U-phase inverter. The above control system for obtaining the third-order superimposition voltage amplitude Bu from the first deviation ΔVbu is an ordinary proportional-integral control (PI control) system. Furthermore, the third-order superimposition voltage amplitude Bu passes through a third-order superimposition limiter 105u and is multiplied by sin3θ which is a frequency that is 3 times the frequency of a fundamental wave Asinθ as a target AC voltage. The resultant Bu(sin3θ) is an instantaneous value of a third-order superimposition voltage to be superimposed. An adder 106u adds up Asinθ and Bu(sin3θ). The resultant sum is a U-phase inverter output voltage command value Vru. The corresponding output of the gradationally controlled inverter is controlled so as to satisfy this command value.

Next, in the V phase, a subtractor 101v calculates a deviation ΔVbv (also referred to as “second deviation”) between the sub DC bus voltage target value R_Vb and a DC bus voltage detection value Vbv of the sub inverter 3 for the V phase. The deviation ΔVbv is inputted to a V-phase proportional controller 103v which is then used to calculate a control amount Bpv as an output thereof.

An adder 104v adds up: the control amount Bi which is the output of the integral controller 102 and which has been obtained through the control calculation in the U phase; and the V-phase control amount Bpv which is the output of the V-phase proportional controller 103v. The resultant sum is a third-order superimposition voltage amplitude Bv in the V-phase inverter. Furthermore, the third-order superimposition voltage amplitude Bv passes through a third-order superimposition limiter 105v and is multiplied by sin3θ which is a frequency that is 3 times the frequency of the fundamental wave target AC voltage Asinθ. The resultant Bv(sin3θ) is an instantaneous value of a third-order superimposition voltage to be superimposed. An adder 106v adds up Asin(θ+2π/3) which is a fundamental wave for the V phase and Bv(sin3θ). The resultant sum is a V-phase inverter output voltage command value Vrv. The corresponding output of the gradationally controlled inverter is controlled so as to satisfy this command value.

Next, in the W phase, a subtractor 101w calculates a deviation ΔVbw (also referred to as “third deviation”) between the sub DC bus voltage target value R_Vb and a DC bus voltage detection value Vbw of the sub inverter 3 for the W phase. The deviation ΔVbw is inputted to a W-phase proportional controller 103w which is then used to calculate a control amount Bpw as an output thereof. An adder 104v adds up: the control amount Bi which is the output of the integral controller 102 and which has been obtained through the control calculation in the U phase; and the control amount Bpw which is the output of the W-phase proportional controller 103w. The resultant sum is a third-order superimposition voltage amplitude Bw in the W-phase inverter. Furthermore, the third-order superimposition voltage amplitude Bw passes through a third-order superimposition limiter 105w and is multiplied by sin3θ which is a frequency that is 3 times the frequency of the fundamental wave target AC voltage Asinθ. The resultant Bw(sin3θ) is an instantaneous value of a third-order superimposition voltage to be superimposed. An adder 106w adds up Asin(θ+4π/3) which is a fundamental wave for the W phase and Bw(sin3θ). The resultant sum is a W-phase inverter output voltage command value Vrw. The corresponding output of the gradationally controlled inverter is controlled so as to satisfy this command value.

Since the integral controller 102 is shared by the control systems for the three respective phases, the third-order superimposition voltages for the three phases are caused to be approximately equal to one another, and a zero-phase voltage is prevented from being generated. Ideal setting is as follows. That is, the proportional controllers separately provided for the respective phases merely perform fine adjustment, and, regarding a component having been subjected to this fine adjustment, a limiter is provided such that the zero-phase voltage becomes equal to or smaller than a predetermined value.

There is a use in which the only target AC voltage amplitudes A to be adopted are target AC voltage amplitudes A in such a range that the respective characteristics of b_{b1}/A with respect to B do not have extrema, such as target AC voltage amplitudes A in a range from 20 V to 35 V in the characteristics in FIG. 10, for example. In this use, the third-order superimposition limiter in each of the phases may be omitted.

The present embodiment 1 is directed to a gradationally controlled inverter having a configuration in which each of the output voltages of the sub inverter 3 is added to the corresponding output voltage of the main inverter 2 so as to obtain an output voltage. In the gradationally controlled inverter, the voltage Vb of each of the capacitors as DC sources of the sub inverter 3 is controlled to be E/3 based on the input voltage E (=Vdc/2) of the main inverter 2, and furthermore, control is performed such that, even when the target AC voltage amplitude A and the frequency are changed, each third-order superimposition voltage amplitude B at which the corresponding fundamental wave component of the sub inverter 3 becomes 0 is obtained and a third-order superimposed target AC voltage as a voltage obtained by adding a third-order superimposition voltage having the third-order superimposition voltage amplitude B to a fundamental wave target AC voltage having the target AC voltage amplitude A is used as a target AC voltage of the gradationally controlled inverter. As a result, this gradationally controlled inverter can be configured as a nine-level gradationally controlled inverter that enables a filter thereof to be downsized, the inverter eliminating the need for a dedicated power supply on a DC bus of the sub inverter 3 even in a use in which the target AC voltage and the frequency are variable. Therefore, an inverter having a lower weight can be provided.

### Embodiment 2

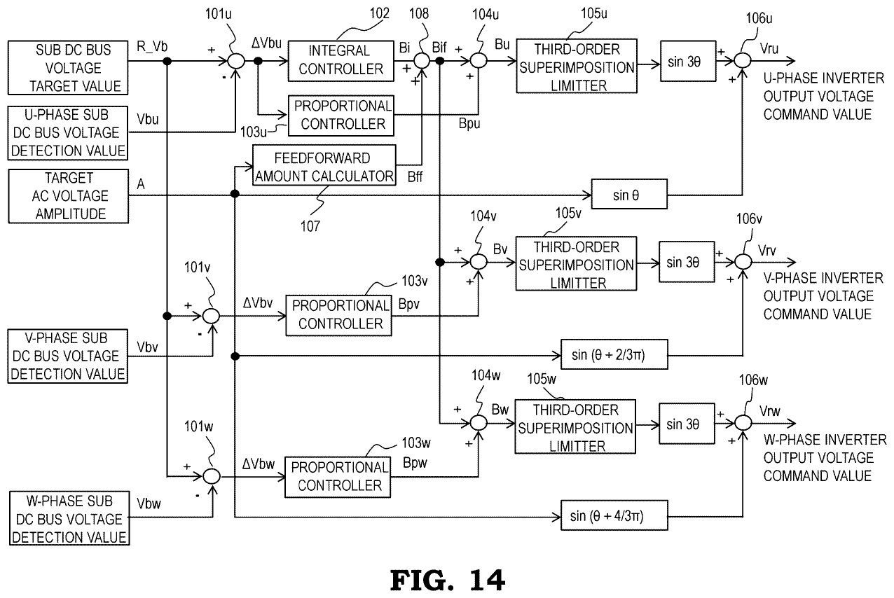

FIG. 14 is a block diagram for explaining calculation for obtaining third-order superimposition voltage amplitudes B of third-order harmonics to be superimposed and inverter output voltage command values Vr (Vru, Vrv, and Vrw) which are third-order superimposed target AC voltages for the U, V, and W phases, in a controller of a power conversion device according to embodiment 2. A configuration of the power conversion device according to the present embodiment 2 is the same as that in FIG. 1.

First, calculation is performed with the U phase being a reference. The subtractor 101u calculates a deviation ΔVbu between the sub DC bus voltage target value R_Vb and the DC bus voltage detection value Vbu of the sub inverter 3 for the U phase. The deviation ΔVbu is inputted to the integral controller 102 which is then used to calculate a control amount Bi as an output thereof. Next, the target AC voltage amplitude A is inputted to a feedforward amount calculator 107 which then outputs a control amount Bff regarding feedforward for a third-order superimposition voltage. An adder 108 adds the control amount Bff to the control amount Bi which is the output of the integral controller 102, and outputs a sum Bif. In addition, the deviation ΔVbu is inputted to the U-phase proportional controller 103u which is then used to calculate a control amount Bpu as an output thereof. The adder 104u adds up the total output amount Bif of the outputs of the integral controller 102 and the feedforward amount calculator 107 and the U-phase control amount Bpu. The resultant sum is a third-order superimposition voltage amplitude Bu. Furthermore, the third-order superimposition voltage amplitude Bu passes through the third-order superimposition limiter 105u and is multiplied by sin3θ which is a frequency that is 3 times the frequency of the fundamental wave Asinθ as a target output AC voltage. The resultant Bu(sin3θ) is an instantaneous value of a third-order superimposition voltage to be superimposed. The adder 106u adds up Asinθ and Bu(sin3θ). The resultant sum is a U-phase inverter output voltage command value Vru. The corresponding output of the gradationally controlled inverter is controlled so as to satisfy this command value.

Next, in the V phase, the subtractor 101v calculates a deviation ΔVbv between the sub DC bus voltage target value R_Vb and the bus voltage detection value Vbv of the sub inverter 3 for the V phase. The deviation ΔVbv is inputted to the V-phase proportional controller 103v which is then used to calculate a control amount Bpv as an output thereof. Next, the adder 104v adds up: the total output amount Bif of the outputs of the integral controller 102 and the feedforward amount calculator 107 obtained through the calculation in the U phase; and the control amount Bpv from the V-phase proportional controller 103v. The resultant sum is a third-order superimposition voltage amplitude Bv. Furthermore, the third-order superimposition voltage amplitude Bv passes through the third-order superimposition limiter 105v and is multiplied by sin3θ which is a frequency that is 3 times the frequency of the target AC fundamental wave Asinθ. The resultant Bv(sin3θ) is an instantaneous value of a third-order superimposition voltage to be superimposed. The adder 106v adds up Asin(θ+2π/3) which is a fundamental wave for the V phase and Bv(sin3θ). The resultant sum is a V-phase inverter output voltage command value Vrv. The corresponding output of the gradationally controlled inverter is controlled so as to satisfy this command value.

Next, in the W phase, the subtractor 101w calculates a deviation ΔVbw between the sub DC bus voltage target value R_Vb and the detection value Vbw of the sub inverter DC bus voltage for the W phase. The deviation ΔVbw is inputted to the W-phase proportional controller 103w which is then used to calculate a control amount Bpw as an output thereof. The adder 104w adds up: the total output amount Bif of the outputs of the integral controller 102 and the feedforward amount calculator obtained through the control calculation in the U phase; and the control amount Bpw from the W-phase proportional controller 103w. The resultant sum is a third-order superimposition voltage amplitude Bw. Furthermore, the third-order superimposition voltage amplitude Bw passes through the third-order superimposition limiter 105w and is multiplied by sin3θ which is a frequency that is 3 times the frequency of the target AC fundamental wave Asinθ. The resultant Bw(sin3θ) is an instantaneous value of a third-order superimposition voltage. The adder 106w adds up Asin(θ+4π/3) which is a fundamental wave for the W phase and Bw(sin3θ). The resultant sum is a W-phase inverter output voltage command value Vrw. The corresponding output of the gradationally controlled inverter is controlled on the basis of this command value.

Here, the feedforward amount calculator 107 obtains, from results calculated as third-order superimposition voltage amplitudes B at each of which the corresponding fundamental wave component b_{b1} of the sub inverter 3 becomes zero, an approximation expression with the target AC voltage amplitude A being a variable amount (variable). By using this approximation expression as a function and incorporating the function into the control, the feedforward amount calculator 107 outputs, as a feedforward amount calculation result, a calculation result of the incorporated function with respect to an inputted target AC voltage amplitude A.

The present embodiment makes it possible to provide a nine-level gradationally controlled inverter that enables a filter thereof to be downsized, the inverter eliminating the need for a dedicated power supply for each of sub inverters and capable of controlling a sub inverter bus voltage at a higher speed so that the inverter is applicable to a load requiring a steeper change and has a low weight.

### Embodiment 3

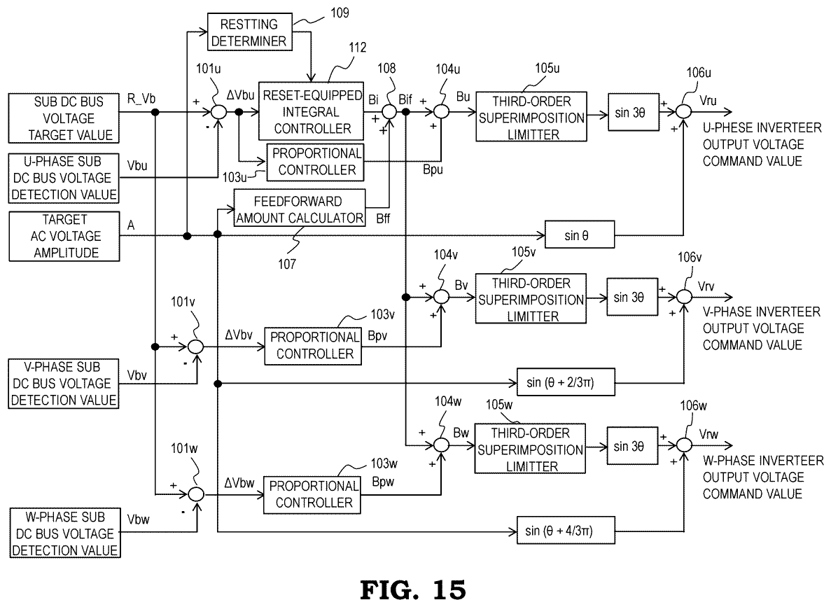

FIG. 15 is a block diagram for explaining calculation for obtaining third-order superimposition voltage amplitudes B of third-order harmonics to be superimposed and inverter output voltage command values Vr (Vru, Vrv, and Vrw) which are third-order superimposed target AC voltages for the U, V, and W phases, in a controller of a power conversion device according to embodiment 3. A configuration of the power conversion device according to the present embodiment 3 is the same as that in FIG. 1.

First, calculation is performed with the U phase being a reference. The subtractor 101u calculates a deviation ΔVbu between the sub DC bus voltage target value R_Vb and the DC bus voltage detection value Vbu of the sub inverter 3 for the U phase. The deviation ΔVbu is inputted to a reset-equipped integral controller 112 which is then used to calculate a control amount Bi as an output thereof.

The reset-equipped integral controller 112 has a function of, when receiving a resetting signal, returning an accumulated integration amount to an initial value. The resetting signal as a trigger for the resetting is a signal outputted from a resetting determiner 109. Regarding an intersection at which the output fundamental wave component b_{b1} of each of the sub inverters becomes 0, there is a condition that, as in FIG. 10, the inputted target AC voltage amplitude A has changed from A with which one said intersection is present to A with which two said intersections are present. Under this condition, the resetting determiner 109 outputs a resetting toggle signal only in the corresponding calculation cycle.

The initial value is equal to or smaller than an appropriate value of a required third-order superimposition voltage amplitude B. Regarding an appropriate value of B under the condition that two said intersections are present as described above, B at an intersection shown on the left side selected in order to perform matching in terms of the directionality of control is used as an appropriate solution as described in embodiment 1.

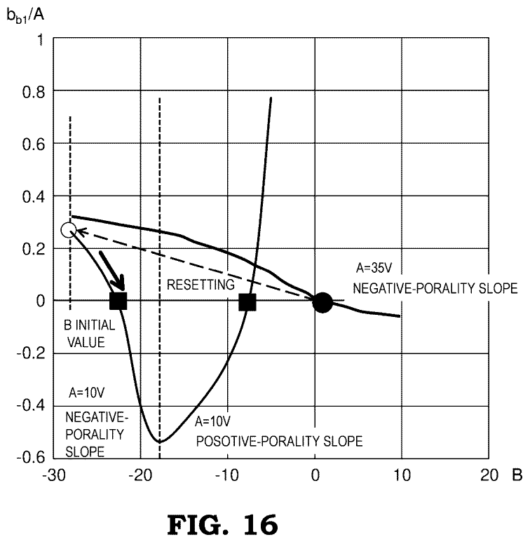

FIG. 16 shows, for example, that the control amount Bi accumulated in the integral controller is returned to the initial value through resetting such that the resetting causes A to shift to a negative-polarity slope region obtained at 10 V, in the relationship between each third-order superimposition voltage amplitude B and the corresponding fundamental wave component b_{b1} of the output voltage of the sub inverter 3 when the target AC voltage amplitude A has decreased (here, under a condition that A has decreased from 35 V to 10 V).

In the present embodiment 3, a calculation result at which the target AC voltage amplitude A is 0 is used as the initial value on the basis of the approximation expression (described in embodiment 2) with the target AC voltage amplitude A being a variable parameter (variable), the approximation expression having been obtained from results calculated as third-order superimposition voltage amplitudes B at each of which the corresponding fundamental wave component b_{b1} of the sub inverter 3 becomes zero.

As a matter of course, an approximation expression that varies according to the value of A may be used. This approximation expression may be formulated from plotted values each obtained by subtracting, in the negative direction, a margin voltage from an appropriate solution of B with respect to the target AC voltage amplitude A, and may be incorporated as a function into the controller 11.

Alternatively, the operation of the controller 11 can be realized also through, instead of a method that includes performing complicated calculation on a function each time, a method that includes: obtaining solutions to an approximation expression in advance; creating a map by using a list of the results as initial values; saving the map in a memory; and reading the map during a control routine.

Next, the target AC voltage amplitude A which is an amplitude of a fundamental wave is inputted to the feedforward amount calculator 107 which then outputs a control amount Bff regarding feedforward for a third-order superimposition voltage. The adder 108 adds the control amount Bff to the control amount Bi which is the output of the reset-equipped integral controller 112, and outputs Bif. In addition, the deviation ΔVbu is inputted to the U-phase proportional controller 103u which is then used to calculate a control amount Bpu as an output thereof. The adder 104u adds up the total output amount Bif of the outputs of the reset-equipped integral controller 112 and the feedforward amount calculator 107 and the U-phase control amount Bpu. The resultant sum is a third-order superimposition voltage amplitude Bu.

Although feedforward amount calculation described in embodiment 2 is performed in FIG. 15, the feedforward amount calculation may be omitted as in embodiment 1.

Furthermore, the third-order superimposition voltage amplitude Bu passes through the third-order superimposition limiter 105u and is multiplied by sin3θ which is a frequency that is 3 times the frequency of the target AC fundamental wave Asinθ. The resultant Bu(sin3θ) is an instantaneous value of a third-order superimposition voltage to be superimposed. The adder 106u adds up Asinθ and Bu(sin3θ). The resultant sum is a U-phase inverter output voltage command value Vru. The corresponding output of the gradationally controlled inverter is controlled so as to satisfy this command value.

Next, in the V phase, the subtractor 101v calculates a deviation ΔVbv between the sub DC bus voltage target value R_ Vb and the DC bus voltage detection value Vbv of the sub inverter 3 for the V phase. The deviation ΔVbv is inputted to the V-phase proportional controller 103v which is then used to calculate a control amount Bpv as an output thereof. Next, the adder 104v adds up: the total output amount Bif of the outputs of the reset-equipped integral controller 112 and the feedforward amount calculator 107 obtained through the control calculation in the U phase; and the control amount Bpv from the V-phase proportional controller 103v. The resultant sum is a third-order superimposition voltage amplitude Bv. Furthermore, the third-order superimposition voltage amplitude Bv passes through the third-order superimposition limiter 105v and is multiplied by sin3θ which is a frequency that is 3 times the frequency of the target AC fundamental wave Asinθ. The resultant Bv(sin3θ) is an instantaneous value of a third-order superimposition voltage to be superimposed. The adder 106v adds up Asin(θ+2π/3) which is a fundamental wave for the V phase and Bv(sin3θ). The resultant sum is a V-phase inverter output voltage command value Vrv. The corresponding output of the gradationally controlled inverter is controlled so as to satisfy this command value.

Next, in the W phase, the subtractor 101w calculates a deviation ΔVbw between the sub DC bus voltage target value R_Vb and the DC bus voltage detection value Vbw of the sub inverter 3 for the W phase. The deviation ΔVbw is inputted to the W-phase proportional controller 103w which is then used to calculate a control amount Bpw as an output thereof. Next, the adder 104w adds up: the total output amount Bif of the outputs of the reset-equipped integral controller 112 and the feedforward amount calculator 107 obtained through the control calculation in the U phase; and the control amount Bpw from the W-phase proportional controller 103w. The resultant sum is a third-order superimposition voltage amplitude Bw. Furthermore, the third-order superimposition voltage amplitude Bw passes through the third-order superimposition limiter 105w and is multiplied by sin3θ which is a frequency that is 3 times the frequency of the target AC fundamental wave Asinθ. The resultant Bw(sin3θ) is an instantaneous value of a third-order superimposition voltage to be superimposed. The adder 106w adds up Asin(θ+4π/3) which is a fundamental wave for the W phase and Bw(sin3θ). The resultant sum is a W-phase inverter output voltage command value Vrw. The corresponding output of the gradationally controlled inverter is controlled so as to satisfy this command value.

The control method employed in the present embodiment 3 is a modification of the control methods employed in embodiment 1 and embodiment 2, the modification making it possible to provide a nine-level gradationally controlled inverter that enables a filter thereof to be downsized, the inverter having a low weight and enabling decrease in the control calculation amount for controlling a sub inverter bus voltage.

In each of FIG. 13 to FIG. 15, a controller for an operation that starts at inputting of ΔVbu (first deviation) or inputting of ΔVbu and the target AC voltage amplitude A and that ends at outputting of the third-order superimposition voltage amplitude Bu is referred to as “first controller”, a controller for an operation that starts at inputting of ΔVbv (second deviation) and that ends at outputting of the third-order superimposition voltage amplitude Bv is referred to as “second controller”, and a controller for an operation that starts at inputting of ΔVbw (third deviation) and that ends at outputting of the third-order superimposition voltage amplitude Bw is referred to as “third controller”. In the case of including a third-order superimposition limiter, each of the first controller, the second controller, and the third controller includes the third-order superimposition limiter.

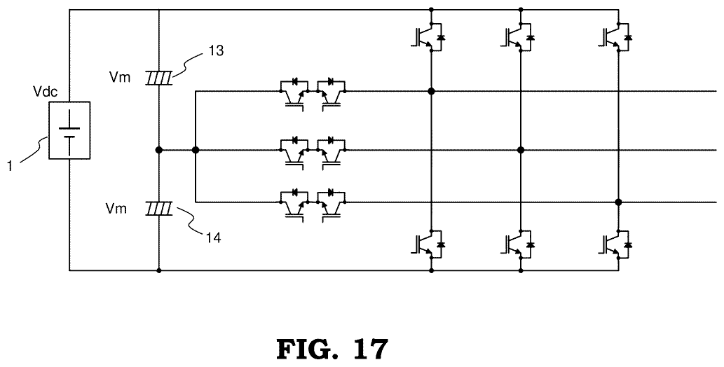

In each of the above embodiments, the main inverter 2 has been described as a neutral point clamped three-level inverter such as one in FIG. 1. Alternatively, it is also possible to use a T-type three-level inverter (such as one shown in FIG. 17) provided with switches that allow currents to bidirectionally flow therethrough and that cause short-circuiting between the neutral point of the DC source 1 and the AC outputs for the respective phases.

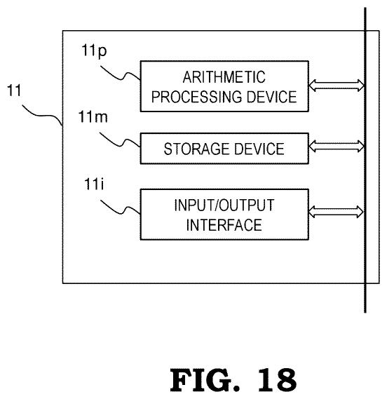

As shown in FIG. 18, the controller 11 shown in FIG. 1 specifically includes: an arithmetic processing device 11p such as a central processing unit (CPU); a storage device 11m through which data is transmitted to or received from the arithmetic processing device 11p; an input/output interface 11i through which a signal is inputted and outputted between the arithmetic processing device 11p and the outside; and the like. As the arithmetic processing device 11p, an application specific integrated circuit (ASIC), an integrated circuit (IC), a digital signal processor (DSP), a field programmable gate array (FPGA), various types of signal processing circuits, and the like may be provided. Also, a plurality of the arithmetic processing devices 11p of the same type or different types may be provided so as to execute allocated respective processes. As the storage device 11m, a random access memory (RAM) configured to allow data to be read therefrom and written thereinto by the arithmetic processing device 11p, a read only memory (ROM) configured to allow data to be read therefrom by the arithmetic processing device 11p, and the like are provided. The input/output interface 11i is composed of, for example: a voltage sensor provided to each of the main inverter 2 and the sub inverter 3; an A/D converter for inputting, to the arithmetic processing device 11p, a sensor signal outputted from a current sensor or the like; a drive circuit for outputting a drive signal to each of the semiconductor switching elements; and the like.

### Embodiment 4

The present embodiment is an embodiment regarding a flying object including any one of the power conversion devices according to embodiments 1 to 3. The flying object according to the present embodiment is, for example, an aircraft, a helicopter, a drone, or a flying car.

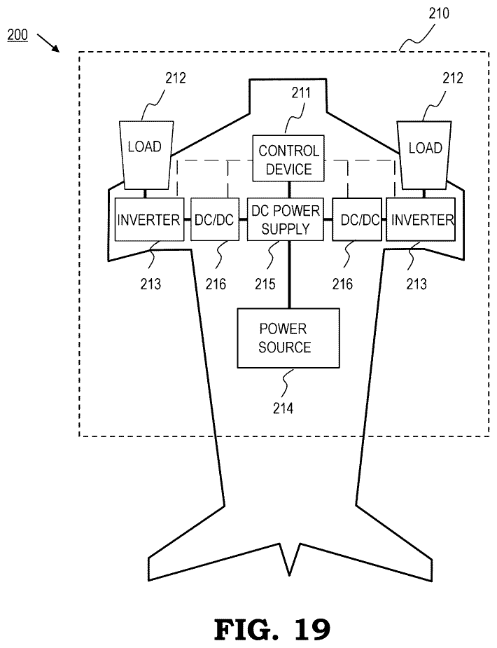

FIG. 19 is a schematic block diagram of a flying object 200 according to embodiment 4. The flying object 200 includes any one of the power conversion devices described in embodiments 1 to 3. The flying object 200 has a propulsion-related power system 210 composed of: a power source 214; a DC power supply 215 connected to the power source 214; DC/DC converters 216 connected to the DC power supply 215 and each including, for example, a step-down chopper circuit which performs conversion into a predetermined voltage; inverters 213 each of which converts, into AC power, DC power stepped down by the corresponding DC/DC converter 216; loads 212 to each of which power is supplied from the corresponding inverter 213; and a controller 211 which controls the DC/DC converters 216 and the inverters 213. Here, each of the loads 212 is a propulsion-related load for obtaining propulsion force and is, for example, an electric motor.

The gradationally controlled inverter of the power conversion device according to embodiment 1, embodiment 2, or embodiment 3 is used as each of the inverters 213 mounted in the flying object 200. Here, the corresponding DC/DC converter 216 corresponds to the DC source 1 in FIG. 1. The controller 211 includes the functions of the controller 11 in FIG. 1. Devices to be mounted in an object that flies in the sky such as the flying object represented by an aircraft are required to have reduced weights and reliability such as properties of being less likely to sustain electric discharge. Considering this, a power conversion device including the gradationally controlled inverter described in embodiment 1, embodiment 2, or embodiment 3 as each of the inverters 213 is mounted in the propulsion-related power system 210. Consequently, reduction in weight can be achieved, and partial discharge can be suppressed to improve reliability.

Although various exemplary embodiments and examples are described in the present application, various features, aspects, and functions described in one or more embodiments are not inherent in a particular embodiment, and can be applicable alone or in their various combinations to each embodiment. Accordingly, countless variations that are not illustrated are envisaged within the scope of the art disclosed herein. For example, the case where at least one component is modified, added or omitted, and the case where at least one component is extracted and combined with a component in another embodiment are included.

### DESCRIPTION OF THE REFERENCE CHARACTERS

1 DC source
2 main inverter
3 sub inverter
4 U-phase sub inverter
5 V-phase sub inverter
6 W-phase sub inverter
11 controller
15 U-phase main inverter
16 V-phase main inverter
17 W-phase main inverter
41, 51, 61 capacitor (power storage element)
102 integral controller
103u U-phase proportional controller
103v V-phase proportional controller
103w W-phase proportional controller
105u, 105v, 105w third-order superimposition limiter
107 feedforward amount calculator
109 resetting determiner
112 reset-equipped integral controller
200 flying object
212 load
215 DC power supply

1. A power conversion device comprising:
three main inverters each of which generates any of a DC voltage E, a DC voltage −E, and a voltage of 0 as an output voltage through switching among E, −E, and 0 by a plurality of semiconductor switching elements connected in series, the three main inverters respectively being a U-phase main inverter, a V-phase main inverter, and a W-phase main inverter each having an output terminal;
three sub inverters each of which has a plurality of semiconductor switching elements and a power storage element for supplying a DC voltage Vb and each of which generates any of Vb, −Vb, and the voltage of 0 as an output voltage through switching among Vb, −Vb, and 0, the three sub inverters respectively being a U-phase sub inverter, a V-phase sub inverter, and a W-phase sub inverter which are respectively connected to the output terminal of the U-phase main inverter, the output terminal of the V-phase main inverter, and the output terminal of the W-phase main inverter such that a voltage obtained by adding the output voltage of the sub inverter for each of the phases to the output voltage of the main inverter for the phase becomes an output voltage for the phase, to allow AC voltages for the three phases to be outputted; and
a controller which controls the plurality of semiconductor switching elements in each of the three main inverters and the plurality of semiconductor switching elements in each of the three sub inverters, wherein
the controller
sets a target voltage of the voltage Vb of the power storage element for each of the phases to E/3,
sets, as target AC voltages of the output voltages for the respective phases, third-order superimposed target AC voltages each obtained by adding, to a fundamental wave target AC voltage as a target AC voltage of a corresponding target fundamental wave, a corresponding third-order superimposition voltage as a third-order harmonic having a frequency that is 3 times a frequency of the fundamental wave,
sets an amplitude of each of the third-order superimposition voltages such that a fundamental wave component included in the output voltage of the sub inverter for the corresponding phase becomes 0, and
controls the semiconductor switching elements in each of the main inverters for the respective phases and the semiconductor switching elements in each of the sub inverters for the respective phases.

2. The power conversion device according to claim 1, wherein
the controller
obtains, with respect to a target AC voltage amplitude A as an amplitude of the fundamental wave target AC voltages, a third-order superimposition voltage amplitude B which is an amplitude of each of the third-order superimposition voltages and at which an amplitude b_{b1} of the fundamental wave component included in the output voltage of the sub inverter for the corresponding phase becomes 0,
adds the third-order superimposition voltage having the obtained third-order superimposition voltage amplitude B to the corresponding fundamental wave target AC voltage having the target AC voltage amplitude A, to obtain a sum, and
sets the sum as the corresponding third-order superimposed target AC voltage.

3. The power conversion device according to claim 2, wherein
the controller
has, in an approximation expression having the A as a variable, the B at which the b_{b1} becomes 0, and
obtains the B by using the approximation expression.

4. The power conversion device according to claim 2, wherein
the controller includes
a first controller which receives a first deviation as a deviation between the target voltage of each of the power storage elements and a detection value of the voltage of the power storage element in the U-phase sub inverter and which outputs Bu as the third-order superimposition voltage amplitude for the U phase,
a second controller which receives a second deviation as a deviation between the target voltage of each of the power storage elements and a detection value of the voltage of the power storage element in the V-phase sub inverter and which outputs Bv as the third-order superimposition voltage amplitude for the V phase, and
a third controller which receives a third deviation as a deviation between the target voltage of each of the power storage elements and a detection value of the voltage of the power storage element in the W-phase sub inverter and which outputs Bw as the third-order superimposition voltage amplitude for the W phase, and
the controller sets the third-order superimposed target AC voltages for the respective phases by using the respective outputs of the first controller, the second controller, and the third controller.

5. The power conversion device according to claim 4, wherein
the first controller is configured to obtain the Bu by adding up an output of an integral controller which receives the first deviation and an output of a U-phase proportional controller which receives the first deviation,
the second controller is configured to obtain the Bv by adding up the output of the integral controller and an output of a V-phase proportional controller which receives the second deviation, and
the third controller is configured to obtain the Bw by adding up the output of the integral controller and an output of a W-phase proportional controller which receives the third deviation.

6. The power conversion device according to claim 4, wherein
the first controller is configured to obtain the Bu by adding up an output of an integral controller which receives the first deviation, an output of a feedforward amount calculator which receives the target AC voltage amplitude A, and an output of a U-phase proportional controller which receives the first deviation,
the second controller is configured to obtain the Bv by adding up the output of the integral controller, the output of the feedforward amount calculator, and an output of a V-phase proportional controller which receives the second deviation, and
the third controller is configured to obtain the Bw by adding up the output of the integral controller, the output of the feedforward amount calculator, and an output of a W-phase proportional controller which receives the third deviation.

7. The power conversion device according to claim 5, wherein the integral controller has a function of resetting and resets an integration amount of the integral controller to an initial value in response to a command from a resetting determiner which determines, on the basis of the target AC voltage amplitude A, whether or not to perform the resetting.

8. The power conversion device according to claim 4, wherein each of the first controller, the second controller, and the third controller includes a third-order superimposition limiter which sets an upper limit of a corresponding one of values of the Bu, the Bv, and the Bw.

9. The power conversion device according to claim 8, wherein the upper limit to be set by the third-order superimposition limiter is set on the basis of the target AC voltage amplitude A.

10. A flying object comprising:
a power source;
a load which uses power of the power source; and
the power conversion device according to claim 1 as a power conversion device that converts power from the power source and that supplies power obtained by the conversion to the load.

11. The power conversion device according to claim 6, wherein the integral controller has a function of resetting and resets an integration amount of the integral controller to an initial value in response to a command from a resetting determiner which determines, on the basis of the target AC voltage amplitude A, whether or not to perform the resetting.

12. The power conversion device according to claim 5, wherein each of the first controller, the second controller, and the third controller includes a third-order superimposition limiter which sets an upper limit of a corresponding one of values of the Bu, the Bv, and the Bw.

13. The power conversion device according to claim 6, wherein each of the first controller, the second controller, and the third controller includes a third-order superimposition limiter which sets an upper limit of a corresponding one of values of the Bu, the Bv, and the Bw.

14. The power conversion device according to claim 7, wherein each of the first controller, the second controller, and the third controller includes a third-order superimposition limiter which sets an upper limit of a corresponding one of values of the Bu, the Bv, and the Bw.

15. The power conversion device according to claim 12, wherein the upper limit to be set by the third-order superimposition limiter is set on the basis of the target AC voltage amplitude A.

16. The power conversion device according to claim 13, wherein the upper limit to be set by the third-order superimposition limiter is set on the basis of the target AC voltage amplitude A.

17. The power conversion device according to claim 14, wherein the upper limit to be set by the third-order superimposition limiter is set on the basis of the target AC voltage amplitude A.

18. A flying object comprising:
a power source;
a load which uses power of the power source; and
the power conversion device according to claim 2 as a power conversion device that converts power from the power source and that supplies power obtained by the conversion to the load.

19. A flying object comprising:
a power source;
a load which uses power of the power source; and
the power conversion device according to claim 3 as a power conversion device that converts power from the power source and that supplies power obtained by the conversion to the load.

20. A flying object comprising:
a power source;
a load which uses power of the power source; and
the power conversion device according to claim 4 as a power conversion device that converts power from the power source and that supplies power obtained by the conversion to the load.
